(19) United States
(12) Patent Application Publication
(10) Pub. No.: US 2026/0044745 A1
(43) Pub. Date: Feb. 12, 2026

(54) MEMORY-CONSTRAINED ATTENTION IN MACHINE LEARNING MODELS

(71) Applicant: QUALCOMM Incorporated, San Diego, CA (US)

(72) Inventors: Dalton James JONES, Cupertino, CA (US); Junyoung PARK, Palo Alto, CA (US); Matthew James MORSE, New York, NY (US); Raghavv GOEL, San Diego, CA (US); Mukul GAGRANI, Milpitas, CA (US); Mingu LEE, San Diego, CA (US); Matthew Harper LANGSTON, Beacon, NY (US); Pierre-David LETOURNEAU, Austin, TX (US); Christopher LOTT, San Diego, CA (US)

(21) Appl. No.: 18/798,637

(22) Filed: Aug. 8, 2024

(51) Int. Cl. G06N 3/0985; G06N 3/04

(52) U.S. Cl. CPC G06N 3/0985; G06N 3/04

(57) ABSTRACT

Certain aspects of the present disclosure provide techniques and apparatus for machine learning. In an example method, a machine learning model comprising a plurality of layers, and a set of input data for the machine learning model, are accessed. A combination of hyperparameters for the machine learning model is selected based on the set of input data, comprising selecting, for each respective layer of the plurality of layers, a respective cache size based on the input data. The machine learning model is deployed according to the combination of hyperparameters.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large models (e.g., deep neural networks, large language models (LLMs), large vison models (LVMs), large multimodal models (LMMs), and the like) to process and generate output data. Often, machine learning models induce substantial computational expense in inferencing (e.g., generating model output). This expense is particularly problematic on resource-constrained devices (e.g., smartphones). Some attempts to mitigate the computational expense include caching intermediate values during inferencing for subsequent use. However, given the architectures of modern models, such caches rapidly become unacceptably large and often exceed available memory space.

### BRIEF SUMMARY

Certain aspects of the present disclosure provide a processor-implemented method, comprising: accessing a machine learning model comprising a plurality of layers; accessing a set of input data for the machine learning model; selecting a first combination of hyperparameters for the machine learning model based on the set of input data, comprising selecting, for each respective layer of the plurality of layers, a respective cache size based on the input data; and deploying the machine learning model according to the first combination of hyperparameters.

Certain aspects of the present disclosure provide a processor-implemented method, comprising: accessing a machine learning model comprising a plurality of layers, wherein each respective layer of the plurality of layers is associated with a respective cache size selected based on testing data after training the machine learning model; processing input data to generate output data using the machine learning model, comprising: processing data using a first layer of the plurality of layers, wherein the first layer uses a first cache having a first cache size to store intermediate data; and processing data using a second layer of the plurality of layers, wherein the second layer uses a second cache having a second cache size different than the first cache size to store intermediate data; and outputting the output data.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for optimizing machine learning model hyperparameters, according to some aspects of the present disclosure.

FIG. 2 depicts example architecture for memory-constrained attention, according to some aspects of the present disclosure.

FIG. 3 depicts an example hyperparameter combination for memory-constrained attention, according to some aspects of the present disclosure.

FIG. 4 is a flow diagram depicting an example method for optimizing machine learning model parameters, according to some aspects of the present disclosure.

FIG. 5 is a flow diagram depicting an example method for determining normalization statistics for memory-constrained attention, according to some aspects of the present disclosure.

FIG. 6 is a flow diagram depicting an example method for performing memory-constrained attention using machine learning models, according to some aspects of the present disclosure.

FIG. 7 is a flow diagram depicting an example method for normalizing, quantizing, and caching data using optimized hyperparameters, according to some aspects of the present disclosure.

FIG. 8 is a flow diagram depicting an example method for efficient machine learning, according to some aspects of the present disclosure.

FIG. 9 is a flow diagram depicting an example method for efficient machine learning runtime, according to some aspects of the present disclosure.

FIG. 10 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for improved hyperparameter selection are provided.

In a wide variety of machine learning model architectures, attention (e.g., self-attention) is used to generate model output. For example, many models (such as LLMs, LVMs, and the like) use transformer-based self-attention operations. Generating attention scores during data processing generally includes generating a set of intermediate data (e.g., tensors) for each element of the data (e.g., each token in an input sequence). For example, for each token, the model may compute a key tensor (also referred to in some aspects as the “keys”), a value tensor (also referred to in some aspects as the “values”), and a query tensor (also referred to in some aspects as the “queries”). As used herein, a “token” can generally correspond to any logical element of data. For example, in the case of LLMs, the tokens are generally words, phrases, characters, symbols, or portions thereof. In the case of LVMs, the tokens may correspond to pixels (e.g., in an image).

Attention is generally computed for each token with respect to one or more other tokens based on the respective intermediate tensors for each token. Therefore, in some aspects, intermediate data caching can be used to reduce computational expense of the model (e.g., to cache intermediate data that will be used to process subsequent data). For example, in some models, the keys and values of one or more tokens may be cached (referred to in some aspects as “key-value caching” or “KV caching”) for reuse in generating attention data for subsequent tokens. As used herein, a “cache” may generally refer to any memory used to store the intermediate data during processing. Similarly, “caching” data may refer to storing the data in any such memory. Further, “evicting” data from a cache may refer to removing or deleting the data from the cache, marking the corresponding memory address space as unused, overwriting the data in the cache, and the like.

While key-value (KV) caches can significantly reduce the computational expense of generating model output, these caches grow rapidly and often become a severe memory bottleneck, particularly for devices with limited memory and/or when performing long-context generation (e.g., generating output based on a relatively large input prompt). For example, the memory consumed by the KV cache can exceed the footprint of the model itself (even for large models having millions or billions of parameters). Additionally, it is often beneficial to cache the intermediate tensors at each layer of the model, further exacerbating the problems caused by memory constraints.

Some approaches to mitigate these concerns include selective caching (e.g., where a subset of the intermediate data, such as data for a subset of the tokens, is cached, and/or where a subset of the intermediate data is evicted or removed from the cache during processing). In some aspects, removing the intermediate data associated with a given token may be referred to as “evicting” the token or as “token eviction.” For example, if the key tensor and value tensor of a given token are removed from the cache, it may be said that the given token was evicted from the cache.

There are a variety of approaches to token eviction (referred to in some aspects as “eviction policies”) to decide which key-value pair(s) to remove from the memory. For example, tokens having low attention scores may be evicted. However, the particular eviction policy used may have a substantial impact on the performance (e.g., accuracy) of the model, and may vary based on the task and domain, where the domain of a task or model generally refers to the universe of input data that is expected to be used during runtime. In some aspects, the domain may refer to the distribution of “normal” or “expected” data samples that will be used as input. For example, the domain of an LLM trained to assist in medical tasks may correspond to medical-related natural language text, and the task may correspond to suggesting diagnoses based on provided symptoms. It can be difficult or impossible to find an optimal (or at least improved) eviction policy for a given task and model.

As another example of attempts to mitigate the memory burden of the cache(s), some attempts have focused on quantization of the intermediate tensors prior to caching the quantized tensors in order to reduce the memory footprint of the stored data. However, quantization inherently introduces inaccuracies through quantization losses or error, which can be compounded if an inappropriate quantization scheme is used (which, as discussed above, may depend on the particular model, task, and domain).

As yet another example, some solutions have allotted smaller memory budgets to the caches of layers deeper in the model, with the assumption that early layers are more important and therefore caching more tokens in these early layers may help preserve privacy, while caching fewer tokens in later layers may reduce the memory footprint without substantial accuracy reduction. However, these heuristics-based approaches again fail to understand or allow for the highly domain-, task-, and model-specific features that affect how memory budgets impact model performance.

In some aspects of the present disclosure, techniques are provided for adaptive or dynamic hyperparameter optimization (or at least adjustment or selection) to minimize (or at least reduce) memory footprint of machine learning models (e.g., of the caches used while processing data using the model) while maximizing (or at least increasing or preserving) the accuracy of the model.

Generally, the hyperparameters that can be optimized or evaluated can vary depending on the particular implementation. In some aspects, techniques are provided to select values for hyperparameters including the cache eviction policy (or policies) used, the quantization scheme(s) used, and/or the cache size(s) used. In some aspects, techniques are provided to select layer-specific hyperparameters, such as where each layer of a model may have a different allowable cache size, a different eviction policy, a different quantization scheme, and the like. In some aspects, once a machine learning model is trained, testing data from the particular domain and/or task for which the model will be used can be processed to adaptively select effective cache hyperparameters at each layer of the model.

Advantageously, by optimizing (or at least improving) the cache hyperparameters per layer, aspects of the present disclosure can enable substantially improved model performance (e.g., accuracy, recall, perplexity, and the like), even with long context inputs (e.g., where the inputs include a number of tokens that may far exceed the available cache space per layer).

### Example Workflow for Optimizing Machine Learning Model Hyperparameters

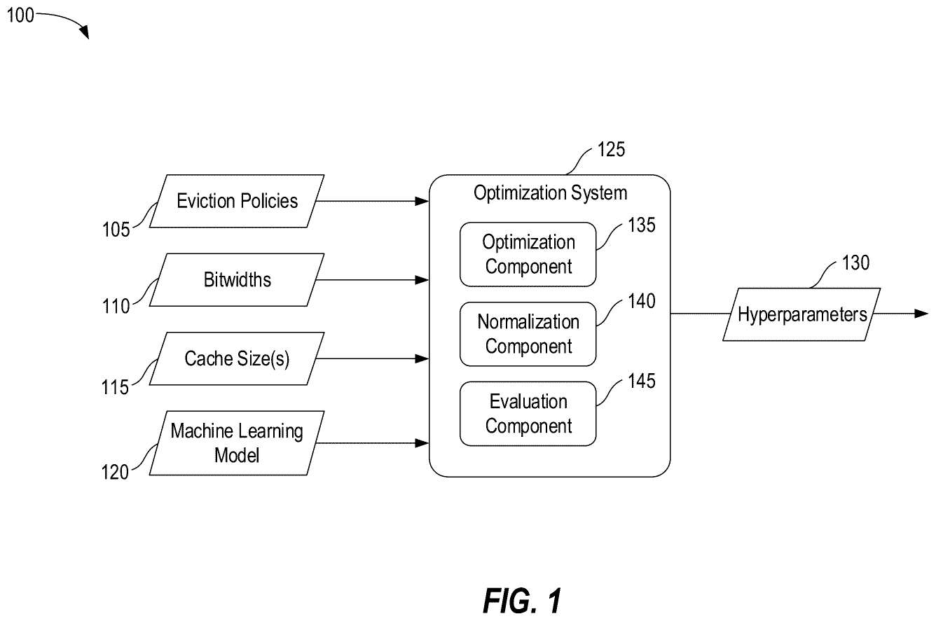

FIG. 1 depicts an example workflow 100 for optimizing (or at least improving) machine learning model hyperparameters, according to some aspects of the present disclosure.

In the illustrated example, an optimization system 125 accesses a variety of data including eviction policies 105, bitwidths 110, cache sizes 115, and a machine learning model 120 to select, adjust, or generate a set of hyperparameters 130 for the machine learning model 120 (e.g., cache hyperparameters defining how data is managed using the cache(s), such as a KV cache for each layer). As used herein, “accessing” data may generally include receiving, requesting, retrieving, generating, collecting, obtaining, or otherwise gaining access to the data. For example, the optimization system 125 may access the machine learning model 120 from a training system that trained the machine learning model 120, and/or may receive the eviction policies 105, bitwidths 110, and/or cache sizes 115 from an inferencing system that will use the trained machine learning model during runtime.

In the illustrated example, the eviction policies 105, bitwidths 110, and cache sizes 115 are generally representative of cache hyperparameters that affect or control how intermediate data is processed and/or cached while processing data using the machine learning model 120. In some aspects, multiple alternatives or options are indicated for each such hyperparameter. For example, the eviction policies 105 may include multiple different strategies or guidelines for token eviction that can be implemented by the inferencing system, such as a token omission via attention (TOVA), heavy-hitter oracle (H₂O), robust cache omission (RoCo), mixed-precision KV (MiKV), and the like.

As another example, the bitwidths 110 may generally represent or include various quantization schemes that can be implemented by the inferencing system, such as indicating the bitwidths (e.g., four bits, eight bits, and the like) to which the intermediate tensors can be quantized prior to caching. As yet another example, the cache size(s) 115 may include the various memory budgets that may be allocated for the KV cache of each layer (e.g., the number of tokens that can be cached for each layer). In some aspects, the cache sizes 115 for each layer may sum or aggregate to a number that is no greater than a defined maximum memory footprint or size. That is, if there is a maximum footprint allocated to KV caches for inferencing using the machine learning model 120, the optimization system 125 may select cache sizes for each layer of the model such that the total size (of all layers combined) is less than or equal to the maximum footprint allocated for the model.

In some aspects, some or all of the indicated hyperparameters can include discrete alternatives (e.g., different eviction policies). In some aspects, some or all of the hyperparameters may include continuous value alternatives. In some aspects, the alternative cache hyperparameters may be constrained to a relatively limited set of discrete alternatives from a pool of many alternatives. For example, the cache sizes 115 may be constrained to selection of either a small cache (e.g., up to two-thousand tokens), a medium cache (e.g., up to five-thousand tokens), or a large cache (e.g., up to eight-thousand tokens), rather than allowing the optimization system 125 to select any size (e.g., between zero and ten thousand tokens). As another example, the bitwidths 110 may be constrained to a relatively smaller set of specific values (e.g., three bits, four bits, eight bits, etc.).

Although the illustrated example depicts eviction policies 105, bitwidths 110, and cache sizes 115 as discrete examples, in some aspects, additional or alternative cache characteristics or hyperparameters may be evaluated by the optimization system 125.

The machine learning model 120 is generally representative of any model that uses attention mechanism(s) in one or more layers or components (e.g., transformers) to process input data. For example, the machine learning model 120 may correspond to an LLM, an LVM, an LMM, and the like. In some aspects, the machine learning model 120 is representative of a model that uses caching (e.g., KV caching) to facilitate efficient attention.

In the illustrated example, the optimization system 125 includes an optimization component 135, a normalization component 140, and an evaluation component 145. Though depicted as discrete components for conceptual clarity, in some aspects, the operations of the optimization component 135, the normalization component 140, and the evaluation component 145 may be combined or distributed across any number and variety of components and systems, and may be implemented using hardware, software, or a combination of hardware and software. In other aspects, the optimization system 125 may include additional or fewer components.

In some aspects, the optimization component 135 can use a variety of optimization algorithms or techniques to select combinations of hyperparameters (from the eviction policies 105, bitwidths 110, and cache sizes 115) for evaluation. For example, the optimization component 135 may use a Bayesian optimization operation to iteratively select and evaluate various combinations, or may use other approaches such as a genetic algorithm, a simulated annealing operation, and the like. In some aspects, the optimization component 135 may select a combination of hyperparameters for evaluation. Based on how the model performs using the selected combination, the optimization component 135 may then select another combination and proceed iteratively until termination criteria (e.g., a maximum number of iterations, a minimum performance, and the like) is reached. The best-performing combination may then be output as the hyperparameters 130.

As used in various aspects, a “combination” of hyperparameters may generally refer to a selection of a specific value or category for each available cache hyperparameter (e.g., each hyperparameter that can be changed by the optimization component 135) for each layer (or other component or combination of components) of the model. For example, the combination of hyperparameters 130 may include, for each respective layer of the machine learning model 120, a respective eviction policy 105 for the KV cache of the respective layer, a respective quantization bitwidth 110 for the intermediate tensors in the KV cache for the respective layer, and a respective cache size 115 for the KV cache of the respective layer.

In the illustrated example, the normalization component 140 may be used to collect or determine various statistics or characteristics for the machine learning model 120 based on testing data in order to facilitate improved quantization of the intermediate tensors. For example, in some aspects, normalizing the intermediate tensors (e.g., the keys and values) of each layer to a defined range (e.g., between −1 and 1, inclusive) prior to quantization may substantially reduce the error introduced by the quantization process. In some aspects, therefore, while the optimization system 125 is evaluating alternative combinations of hyperparameters for the cache, the normalization component 140 can collect tensor statistics to help drive improved normalization during runtime.

For example, in some aspects, the normalization component 140 may determine values such as the mean or average value of each tensor, the maximum value in each tensor, and the like. In some aspects, the normalization component 140 determines per-channel normalization data for each intermediate tensor (e.g., the tensor(s) that may be cached during runtime) at each layer of the model. For example, for each given intermediate tensor (e.g., the keys tensor) in each given layer of the model, the normalization component 140 may determine, for each respective channel of the given tensor, a respective average value of the elements in the respective channel and a respective maximum value of the elements in the respective channel. During runtime, each element in a given channel can then be normalized, such as by subtracting the corresponding average value of the channel (determined during testing) and dividing the resulting difference by the absolute value of the corresponding maximum value in the channel (determined during testing).

In some aspects, conventional minimum/maximum quantization schemes may perform poorly due to outlier values in the intermediate data. However, in some aspects, some of the intermediate tensors (e.g., the keys and values) may exhibit substantial structure (e.g., where the elements of each channel tend to be more similar to each other than to elements of other channels). Thus, per-channel normalization can substantially reduce the quantization error, even at relatively small bitwidths (e.g., four bits). In some aspects, as discussed above and in more detail below, the normalization component 140 can evaluate or determine the tensor characteristics based on testing data that corresponds to the domain and/or task for which the model will be used, while the testing data is used to evaluate the combinations of hyperparameters.

In the illustrated example, the evaluation component 145 may be used to evaluate the performance of the machine learning model 120 with various combinations of hyperparameters (selected by the optimization component 135) based on testing data. In some aspects, the testing data may generally correspond to input data for the machine learning model 120 that is, in some way, similar to the data that will be processed at runtime. For example, the testing data may correspond to the same domain and/or task for which the model will be used. In some aspects, the testing data may be generally representative of any data that can be input to the machine learning model 120 to generate output values (e.g., predictions, inferences, generated data, and the like).

In some aspects, the evaluation component 145 may process the testing data (or cause the testing data to be processed) using the machine learning model 120 with each given combination of cache hyperparameters, and monitor various performance indicators of the model. For example, in some aspects, the evaluation component 145 may determine the perplexity of the model when the combination of hyperparameters is used (where the perplexity generally refers to how well the model can generate predictions based on new or unseen data), the summarization score of the model when the combination is used (e.g., the Rouge score or other value indicative of the model's ability to summarize input data), and the like.

In some aspects, the evaluation component 145 may use a separate machine learning model to evaluate the performance of the machine learning model 120 with the selected combination of hyperparameters. For example, a separate model (e.g., an LLM) may be trained to compare input texts (e.g., an input prompt and a summary generated by the machine learning model 120 based on the input prompt) to determine their similarity, and this similarity may be used as the summarization score for the machine learning model 120 using the combination of parameters.

Generally, the evaluation component 145 may evaluate a wide variety of performance indicators for the model in order to rank the combinations of hyperparameters. As discussed above, the optimization component 135 may then select a new combination of hyperparameters based at least in part on the evaluation(s) of previous combination(s). For example, the optimization component 135 may use an exploration-exploitation approach to search the optimization space.

As discussed above, once optimization termination criteria are met, the optimization system 125 can output or provide the selected combination of hyperparameters 130. For instance, the optimization system can output or provide the selected combination of hyperparameters that resulted in the highest performance (based on the desired metric(s)) of the machine learning model 120. This allows the optimization system 125 (or other systems) to use the machine learning model 120, in conjunction with the selected hyperparameters 130, to efficiently process data (e.g., with reduced memory footprint) while retaining high model performance (e.g., high accuracy).

### Example Architecture for Memory-Constrained Attention

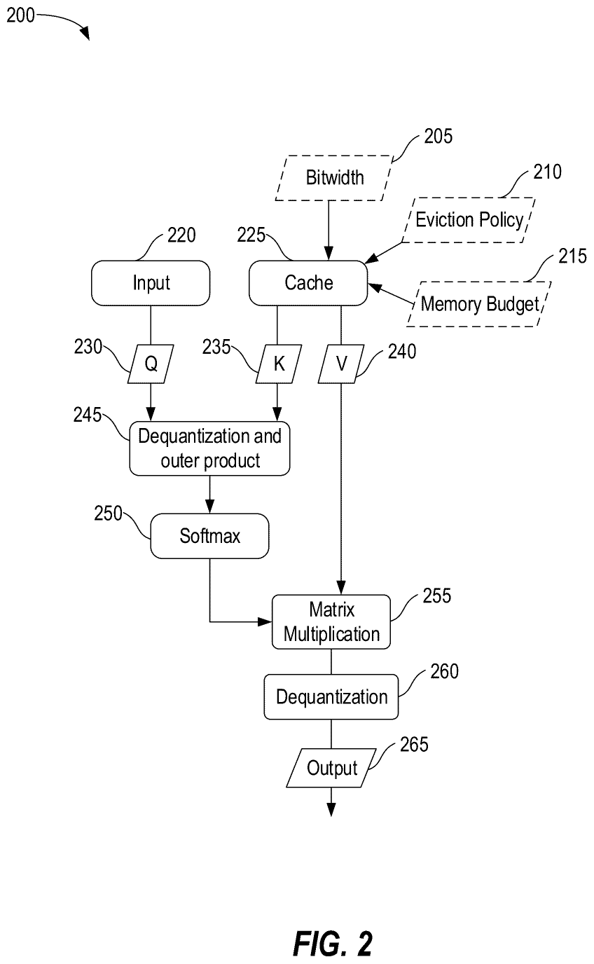

FIG. 2 depicts example architecture 200 for memory-constrained attention, according to some aspects of the present disclosure. In some aspects, the architecture 200 is used by a computing system, such as an optimization system (e.g., the optimization system 125 of FIG. 1) and/or an inferencing system.

In the illustrated example, the architecture 200 corresponds to an attention mechanism in a machine learning model (e.g., the machine learning model 120 of FIG. 1). In the illustrated architecture 200, cache hyperparameters including a bitwidth 205 (e.g., selected from the bitwidths 110 of FIG. 1), an eviction policy 210 (e.g., selected from the eviction policies 105 of FIG. 1), and a memory budget 215 (e.g., selected from the cache sizes 115 of FIG. 1) affect the operations or functionality of the cache 225 for the layer. In some aspects, as discussed above, the cache 225 is a KV cache (e.g., a region of a memory that is used to cache the keys and values of one or more tokens while processing data using the machine learning model). In some aspects, as discussed above, the cache hyperparameters may be determined or selected on a layer-by-layer basis, enabling more efficient and effective machine learning.

Specifically, in the illustrated example, the bitwidth 205 indicates the quantization scheme used when data is added to the cache 225. That is, the bitwidth 205 may indicate the number of integer bits that should be used to store each intermediate tensor in the architecture 200. For example, the bitwidth 205 may indicate that the elements in the key tensor and the value tensor of each token should each be quantized to corresponding four-bit integers, and these quantized tensors should be cached in the cache 225. In some aspects, as discussed above, the bitwidth 205 (or other cache hyperparameters) may also indicate per-channel normalization data, allowing the tensors to be normalized on a per-channel basis prior to being quantized and cached.

In the illustrated example, the eviction policy 210 indicates how the computing system should handle token eviction from the cache 225 during runtime. That is, while processing tokens of input data, the computing system may add the intermediate data (e.g., keys and values) to the cache 225 for each token until the cache 225 reaches its maximum size (denoted by the memory budget 215 in some aspects). At this point, the computing system may select one or more tokens to be evicted from the cache 225 in order to make room to add the intermediate data from the next token. Generally, the eviction policy 210 may specify how the evicted token(s) are to be selected (e.g., how the eviction metrics are computed), how many token(s) are to be evicted each turn, and the like.

Further, in the illustrated example, the memory budget 215 indicates the maximum size of the cache 225 for the layer. For example, the memory budget 215 may indicate the maximum memory footprint (e.g., in bytes), the maximum number of tokens for which intermediate tensors should be cached, and the like. As discussed above, lowering the memory budget 215 for a given layer allows fewer tokens to be cached, which can negatively impact model performance but reduce computational expense. By using dynamic memory budgets for each layer, the computing system can preserve accuracy while reducing memory expense.

In the illustrated example, when input 220 for the architecture 200 is received (which may be input to the model itself, or may be output from a prior layer), the computing system can generate a query tensor 230 for the input 220 using a set of learned query weights. In some aspects, this may be referred to as a linear projection (e.g., multiplying the input 220 by the query weights). In some aspects, this linear projection is performed per-token. That is, each token in the input 220 (which may include a sequence of tokens) may be processed using the query weights to generate a corresponding query tensor 230 for each token. Although not depicted in the illustrated example, in some aspects, the new token may also be processed using a set of key weights and value weights to generate a key tensor and value tensor, respectively. These keys and values can be optionally cached in the cache 225, as discussed below in more detail.

In the depicted architecture 200, to compute attention for the given token, the key tensor(s) 235 from one or more prior tokens are accessed from the cache 225. That is, the attention for a given token may be computed based on the query tensor 230 of the token and the key tensor(s) 235 from one or more prior tokens. In the illustrated example, the query tensor 230 and the key tensor(s) 235 are processed using a dequantization and outer product operation 245. In some aspects, if the key tensors 235 are not quantized in the cache 225, the dequantization and outer product operation 245 may simply be an outer product operation.

In some aspects, if the key tensors 235 are quantized (as discussed above), the computing system may efficiently dequantize the key tensors 235 as part of the dequantization and outer product operation 245. For example, in some aspects, the computing system can apply the key's per-channel multiplicative terms (e.g., scales) to the queries (rather than the keys) using the dequantization and outer product operation 245, which may be substantially faster during inference than first applying the scales to the key tensor 235 and then performing the outer product.

In the illustrated example, the results of the dequantization and outer product operation 245 are then processed using a Softmax operation 250, and the resulting output is accessed by a matrix multiplication operation 255. The matrix multiplication operation 255 further accesses the value tensor(s) 240 (e.g., for the prior token(s)) from the cache 225. In the depicted architecture 200, the matrix multiplication operation 255 performs matrix multiplication between the output combination of the queries and keys (output by the softmax operation 250) and the value tensor 240. In some aspects, the resulting attention output is then processed using a dequantization operation 260 (e.g., to account for the scaling of the value tensor 240), resulting in an output tensor 265 from the architecture 200. This output tensor 265 may then be processed by one or more downstream components as part of further processing using the machine learning model.

In some aspects, as discussed above, each input token from the input 220 may also be processed to generate a key tensor and a value tensor, which may be quantized and added to the cache 225. This can allow the intermediate values for the most recent token to be used for subsequent attention operations (e.g., for the next one or more tokens in the sequence). Further, as discussed above, the computing system may selectively evict tokens from the cache 225 (e.g., when a new token is added) based on the selected eviction policy 210. This can improve computational efficiency while preserving model accuracy.

### Example Hyperparameter Combination for Memory-Constrained Attention

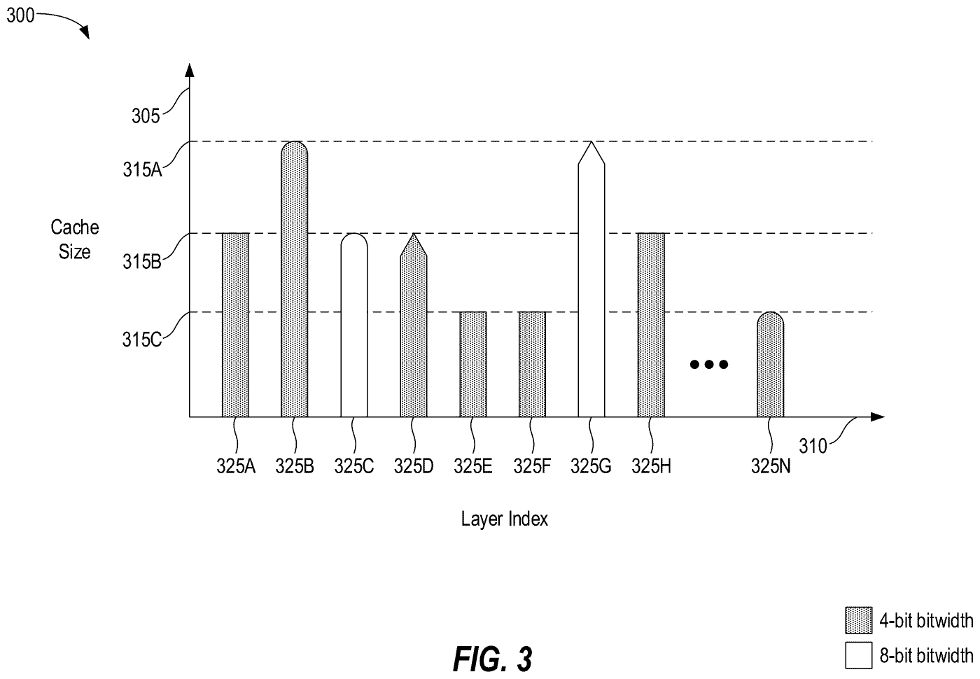

FIG. 3 depicts an example hyperparameter combination for memory-constrained attention, according to some aspects of the present disclosure. In some aspects, the depicted combination is selected by a computing system, such as an optimization system (e.g., the optimization system 125 of FIG. 1) and/or the computing system discussed above with reference to FIG. 2.

In the illustrated example, the selected combination of cache hyperparameters is depicted on a graph 300. Specifically, the cache hyperparameters selected for each layer of a machine learning model are depicted along the horizontal axis 310 by layer index, while the specific values selected for each given layer are indicated by the height of the corresponding bar 325 (e.g., 325A-325N) along the vertical axis 305 (indicating the selected cache size), the stippling of the bar 325 (indicating the selected bitwidth for the cache), and the shape of the bar 325 (indicating the selected eviction policy for the layer).

In the illustrated example, three discrete cache sizes 315A-C are depicted for conceptual clarity. For example, each layer may be assigned a small cache size 315C, a medium cache size 315B, or a large cache size 315A. Though three discrete selections are depicted for clarity, the computing system may use any number of cache size alternatives. Further, although the illustrated example suggests roughly equidistant categories (e.g., where the cache size 315B is roughly twice the cache size 315C, and the cache size 315A is roughly three times the cache size 315C), the particular values may vary depending on the particular implementation.

Additionally, in the illustrated example, three eviction policies are depicted for conceptual clarity. For example, each layer may be assigned a first cache eviction policy (indicated by a square top of the corresponding bar 325), a second cache eviction policy (indicated by a rounded top of the corresponding bar 325), or a third cache eviction policy (indicated by a triangular top of the corresponding bar 325). Although three discrete eviction policies are depicted for conceptual clarity, the computing system may use any number of eviction alternatives.

Further, in the illustrated example, two bitwidths are depicted for conceptual clarity. For example, each layer may be assigned a first bitwidth (e.g., four bits, indicated by stippling of the corresponding bar 325) or a second bitwidth (e.g., eight bits, indicated by a lack of stippling of the corresponding bar 325). Although two discrete bitwidths are depicted for conceptual clarity, the computing system may use any number of bitwidth alternatives.

As discussed above, the computing system may select the cache hyperparameters on a per-layer basis based on testing data (e.g., using a Bayesian optimization approach), resulting in a selected combination of hyperparameters where the particular strategy for each layer may differ from any other layer. Specifically, in the illustrated example, the layer corresponding to the bar 325A uses a medium cache size 315B, a bitwidth of four bits (indicated by the stippling), and the first eviction policy (indicated by the square top). The layer corresponding to the bar 325B uses a large cache size 315A, a bitwidth of four bits (indicated by the stippling), and the second eviction policy (indicated by the rounded top).

As further examples, the layer corresponding to the bar 325F uses a small cache size 315C, a bitwidth of four bits (indicated by the stippling), and the first eviction policy (indicated by the square top). The layer corresponding to the bar 325G uses a large cache size 315A, a bitwidth of eight bits (indicated by the lack of stippling), and the third eviction policy (indicated by the triangular top).

Generally, the combination of hyperparameters may include a selection for any number of hyperparameters (e.g., where the illustrate example depicts three hyperparameters) and for any number of layers (where the illustrated example depicts N layers).

For example, in the illustrated graph 300, the computing system has selected large cache sizes 315A for the layer represented by the bar 325B (relatively early in the model) and for the layer represented by the bar 325G (relatively late in the model). As discussed above, this selection may be performed based on experimentation using testing data. That is, heuristics such as assigning higher cache sizes to earlier layers may fail to provide adequate performance, as these approaches do not account for the particular combination of model, task, and domain that the computing system is actually preparing for. Therefore, aspects of the present disclosure can substantially improve model performance (e.g., through reduced perplexity, improved accuracy, and the like) while minimizing (or at least reducing) model footprint and computational expense.

### Example Method for Optimizing Machine Learning Model Parameters

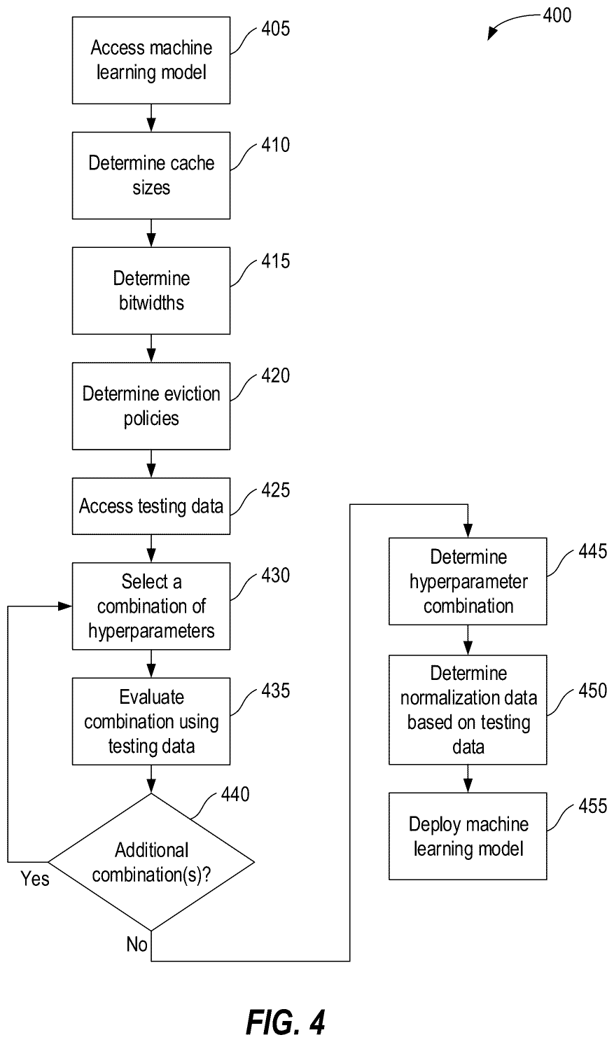

FIG. 4 is a flow diagram depicting an example method 400 for optimizing (or at least improving) machine learning model parameters, according to some aspects of the present disclosure. In some aspects, the method 400 is performed by a computing system, such as an optimization system (e.g., the optimization system 125 of FIG. 1) and/or the computing system discussed above with reference to FIGS. 2-3.

At block 405, the computing system accesses a machine learning model (e.g., the machine learning model 120 of FIG. 1). In some aspects, as discussed above, the computing system accesses the model from another system (e.g., a training system that trained the machine learning model). In some aspects, the computing system trains the machine learning model.

At block 410, the computing system determines a set of allowable cache size(s) for the cache(s) used to facilitate data processing by the model. For example, the computing system may determine the total memory footprint allotted to the KV cache(s) (e.g., by the computing system, or by another system that will use the model during runtime), the allowable cache size(s) for each layer of the model (e.g., the small, medium, large, or other values), and the like. These allowable per-layer sizes may similarly be specified by the computing system, or by another system that will use the model during runtime.

At block 415, the computing system determines a set of allowable bitwidth(s) to be used to quantize intermediate data stored in the cache(s) used to facilitate data processing by the model. For example, the computing system may determine the quantization bitwidths that the computing system (or other system that will use the model during runtime) is capable of using, the subset of possible bitwidths(s) that may actually be used, and the like.

At block 420, the computing system determines a set of allowable eviction policies for the cache(s) used to facilitate data processing by the model. For example, the computing system may determine the eviction policies that the computing system (or other system that will use the model during runtime) is able to perform, the allowable set of policies that are preferred (from a larger set), and the like.

At block 425, the computing system accesses testing data for the model. As discussed above, the testing data is generally representative of any input data used as input to the model, allowing the computing system to evaluate various combinations of cache hyperparameters. In some aspects, the testing data corresponds to or is from the runtime domain (e.g., from the distribution of data that will be processed using the model during runtime). In some aspects, the testing data corresponds to the same task(s) that the model will be used for during runtime. In some aspects, one or more exemplars from the testing data may have corresponding label(s) indicating the desired model output. In some aspects, one or more exemplars may lack such labels, as discussed in more detail below.

At block 430, the computing system selects a combination of hyperparameters to evaluate. Generally, the computing system may use a wide variety of techniques or operations to select the combination of hyperparameters. For example, in some aspects, as discussed above, the computing system may use a Bayesian optimization operation to select the next combination for evaluation. As additional examples, the computing system may use genetic algorithms, simulated annealing operations, exploration-exploitation algorithms, and the like. In some aspects, as discussed above, such optimization techniques may select the next combination for evaluation based at least in part on the results of evaluating one or more prior combinations (if available).

In some aspects, such optimization approaches allow the computing system to select and evaluate a subset of the combinations (rather than brute force evaluation of all combinations). As the search space (defined by the number of hyperparameters, the number of options for each hyperparameter, and the number of layers of the model) may be significantly large, well-tuned optimization techniques can substantially reduce the time and computational resources consumed finding an optimal (or at least improved) combination. However, in some aspects, the computing system may alternatively perform brute force evaluation (e.g., selecting the next combination using any technique, including randomly or in sequence).

At block 435, the computing system evaluates the selected combination using the testing data. For example, as discussed above, the computing system may process some or all of the testing data exemplars using the model in accordance with the selected hyperparameters for each layer (e.g., the particular cache size, eviction policy, and/or cache bitwidth for each layer) to generate model output. Based on this output, the computing system may score or quantify the combination based on aspects such as the perplexity of the model (when the selected combination is used), the summarization score of the model (when the selected combination is used), and so on.

In some aspects, if label(s) are available for some or all of the testing data, the computing system may use these labels to score the combination. For example, the overall accuracy of the model may be determined by comparing the output of the model (using the selected combination of hyperparameters) with the label(s). In some aspects, such as if label(s) are not available, the computing system may compare the output of the model (using the selected combination) with the output of the model (or another model) without such optimizations. For example, the computing system may generate a “ground truth” output by processing a given testing exemplar using the accessed model (or another model, such as a larger and/or more accurate model) with unbounded (or expanded) cache sizes, unquantized (or quantized to higher bitwidth) intermediate tensors, and the like. This output may be compared against the output that the model generates when using the more restrictive hyperparameters in order to evaluate the change in performance (if any) caused by the selected combination of hyperparameters.

At block 440, the computing system determines whether at least one combination remains to be tested. In some aspects, this testing criteria may include a variety of evaluations, such as determining whether a defined number of combinations have been evaluated, determining whether a defined amount of time or computational resources have been spent evaluating, determining whether a preferred level of performance (reflected by the evaluation at block 435) has been reached with at least one combination, determining whether the change in performance across from one iteration to the next is below a threshold, and the like. In some aspects, the particular termination criteria may vary depending on the particular optimization operation(s) used at block 430.

If the computing system determines to evaluate at least one more combination of hyperparameters, the method 400 returns to block 430. If the computing system determines that no additional combinations should be evaluated (or remain), the method 400 continues to block 445. Although the illustrated example depicts a sequential process (selecting and evaluating each combination iteratively) for conceptual clarity, in some aspects, the computing system may evaluate some or all of the combinations in parallel.

At block 445, the computing system determines the hyperparameter combination that exhibited the best (or at least improved) performance during the evaluation performed at block 435. For example, the computing system may select the combination that resulted in the lowest model perplexity, the highest model accuracy, the highest model summarization score, and the like. In various aspects, the computing system determines the hyperparameter combination(s) that exhibit performance that meets or surpasses some threshold (e.g., determines the combinations that resulted in model perplexities that are below a perplexity threshold, determines the combinations that resulted in a model accuracy above an accuracy threshold, etc.) from which any may be provided with the deployed model (e.g., block 455). In further embodiments, the computing system determines the hyperparameter combination that exhibited performance that meets or exceeds some threshold and then stops determining or evaluating further combinations.

At block 450, the computing system may determine normalization data for the model based on the testing data. In some aspects, as discussed above, the normalization data may include, for each intermediate tensor that may be cached at least layer of the model (e.g., each key tensor and each value tensor), data such as the per-channel averages of the tensor, the per-channel maximum values of each tensor, and the like. In some aspects, these per-channel normalization statistics can be collected during the evaluation performed at block 435 (e.g., while the computing system is evaluating each given combination). In some aspects, as discussed above, the per-channel normalization data can be used to normalize each tensor on a per-channel basis prior to quantization, substantially reducing the error introduced by the quantization.

At block 455, the computing system deploys the machine learning model for runtime use (referred to in some aspects as inferencing). Generally, deploying the model may include any number and variety of operations to prepare or provide the model for use locally or by one or more other systems. For example, deploying the model may include transmitting or otherwise providing the machine learning model (or providing a link to where the machine learning model can be accessed), as well as transmitting or otherwise providing or indicating the selected combination of cache hyperparameters (determined at block 450) that maximized (or at least improved) model performance.

### Example Method for Determining Normalization Statistics for Memory-Constrained Attention

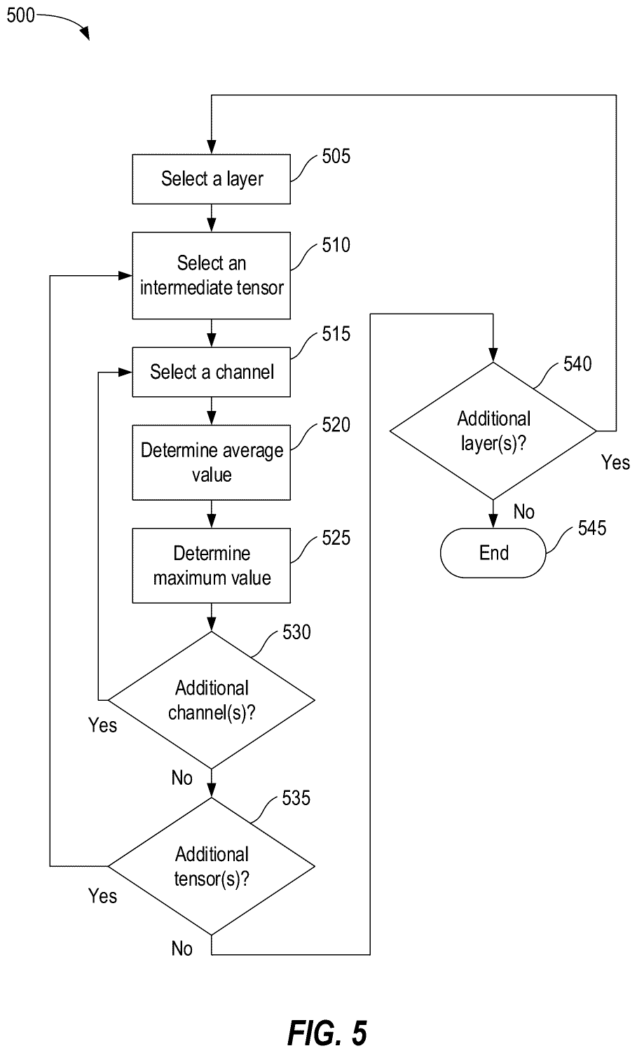

FIG. 5 is a flow diagram depicting an example method 500 for determining normalization statistics for memory-constrained attention, according to some aspects of the present disclosure. In some aspects, the method 500 is performed by a computing system, such as an optimization system (e.g., the optimization system 125 of FIG. 1) and/or the computing system discussed above with reference to FIGS. 2-4. In some aspects, the method 500 provides more detail for the block 450 of FIG. 4.

At block 505, the computing system selects a layer of the machine learning model (e.g., a layer or other component where a cache, such as a KV cache, may be used). Generally, the computing system may select the layer using a variety of techniques, including randomly or pseudo-randomly, as each layer (having a cache) will be evaluated during the method 500.

At block 510, the computing system selects an intermediate tensor, generated by the selected layer, which may be cached during runtime. For example, the computing system may select the key tensor and/or the value tensor in the case of KV caching. Generally, the computing system may select the tensor using a variety of techniques, including randomly or pseudo-randomly, as each tensor that is (or may be) cached will be evaluated during the method 500.

At block 515, the computing system selects a channel from the selected tensor. Generally, the computing system may select the channel using a variety of techniques, including randomly or pseudo-randomly, as each channel in the tensor will be evaluated during the method 500.

At block 520, the computing system determines the average value of the elements in the selected channel in the selected tensor of the selected layer. In some aspects, as discussed above, the average value can be determined based on processing one or more data exemplars using the model (e.g., while evaluating model performance based on combinations of cache hyperparameters) and monitoring or collecting statistics about the average values in the selected channel during these tests. In other aspects, other values of the elements may be determined.

At block 525, the computing system determines the maximum value of the elements in the selected channel in the selected tensor of the selected layer. In some aspects, as discussed above, the maximum value can similarly be determined based on processing one or more data exemplars using the model (e.g., while evaluating model performance based on combinations of cache hyperparameters) and monitoring or collecting statistics about the maximum value in the selected channel during these tests. In some aspects, as discussed above, this per-channel average and per-channel maximum may be referred to as normalization data or statistics for the channel.

At block 530, the computing system determines whether there is at least one additional channel remaining in the selected tensor. If so, the method 500 returns to block 515. If not, the method 500 continues to block 535, where the computing system determines whether there is at least one additional tensor (which may be cached) remaining in the selected layer. If so, the method 500 returns to block 510. If not, the method 500 continues to block 540, where the computing system determines whether there is at least one additional layer (which may use a cache) remaining in the model. If so, the method 500 returns to block 505. If not, the method 500 terminates at block 545.

Although the illustrated example depicts a sequential process (selecting and evaluating each channel of a given tensor iteratively, then evaluating each tensor of a layer iteratively, and finally evaluating each layer of the model) for conceptual clarity, in some aspects, the computing system may evaluate some or all of the layers in parallel.

### Example Method for Performing Memory-Constrained Attention Using Machine Learning Models

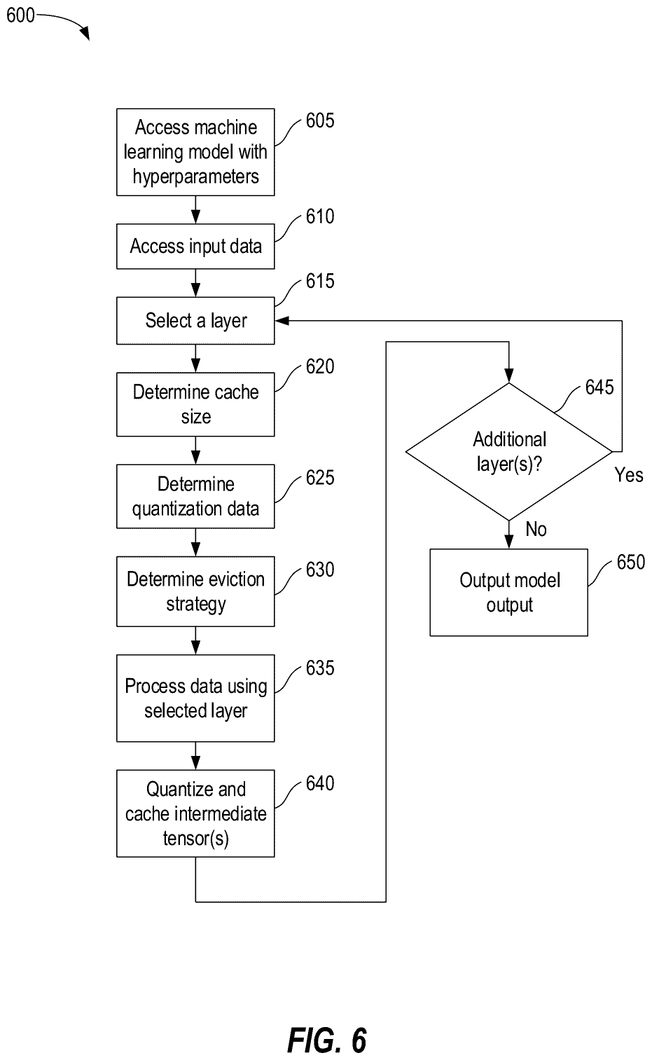

FIG. 6 is a flow diagram depicting an example method 600 for performing memory-constrained attention using machine learning models, according to some aspects of the present disclosure. In some aspects, the method 600 is performed by a computing system, such as an optimization system (e.g., the optimization system 125 of FIG. 1) and/or the computing system discussed above with reference to FIGS. 2-5.

At block 605, the computing system accesses a machine learning model with a set of cache hyperparameters. In some aspects, as discussed above, the set of cache hyperparameters may be selected (e.g., by an optimization system such as the optimization system 125 of FIG. 1) to improve (or maintain) model performance while reducing computational cost (e.g., memory footprint) of executing the model. As discussed above, the particular contents of the combination of hyperparameters may vary depending on the particular implementation, and may include details such as a selected KV cache eviction policy for each layer, a maximum cache size for each layer, a cache bitwidth for each layer, and the like.

At block 610, the computing system accesses input data for the machine learning model. As discussed above, the input data may generally correspond to any data used as input at runtime, depending on the particular task and model. For example, if the machine learning model is a generative model trained to generate images based on textual input, the input data may comprise natural language text describing what image should be created. The computing system may generally access the input from any source, including from a user, from a different application, and the like.

At block 615, the computing system selects a layer of the machine learning model. In some aspects, the computing system selects and executes the layers sequentially (e.g., beginning with the first layer and moving towards the final layer). In some aspects, selecting a layer at block 615 may correspond to selecting a layer that uses a cache (e.g., a KV cache in an attention operation). In some aspects, other layers which do not use caches may be processed as well (though not depicted in the illustrated example).

At block 620, the computing system determines the cache size assigned to the selected layer (as indicated in the hyperparameters accessed at block 605). For example, as discussed above, the cache of the current layer may be limited to a defined memory footprint, a defined number of tokens, and the like.

At block 625, the computing system determines the quantization data or scheme used by the selected layer (as indicated in the hyperparameters accessed at block 605). For example, as discussed above, the intermediate tensors that are stored in the cache may first be normalized (e.g., on a per-channel basis) using statistics determined offline, and/or may be quantized to a specific bitwidth (indicated by the cache hyperparameters) prior to being stored in the cache.

At block 630, the computing system determines the eviction strategy used by the selected layer (as indicated in the hyperparameters accessed at block 605). For example, as discussed above, the intermediate tensors that are stored in the cache may evicted in accordance with the eviction policy when the cache reaches (or nears) its maximum size, where the evictions are performed based on the layer's eviction policy.

At block 635, the computing system processes model data using the selected layer of the model. Generally, the model data processed at the selected layer may include the input data (e.g., if the model is the first layer) and/or data generated by other layers (e.g., by the prior layer of the model). Generally, processing the data using the selected layer can include a variety of operations depending on the particular implementation. In some aspects, processing the data includes at least performing all or part of an attention operation (e.g., generating intermediate tensors such as key tensors, value tensors, and query tensors for the token(s) of the data, and combining these intermediate tensors to generate attention output).

At block 640, the computing system quantizes and caches the intermediate tensor(s) generated during the data processing. For example, as discussed above, the computing system may cache the (quantized) key tensor and/or value tensor for one or more tokens (in the cache for the layer). This may facilitate more efficient data processing of subsequent tokens from the input and/or subsequent inputs to the model.

At block 645, the computing system determines whether there is at least one additional layer (having a cache). If so, the method 600 returns to block 615. If not, the method 600 continues to block 650, where the computing system outputs the model output. That is, the computing system may provide, return, or otherwise output the final output of the machine learning model (generated by the final layer of the model).

### Example Method for Normalizing, Quantizing, and Caching Data Using Optimized Hyperparameters

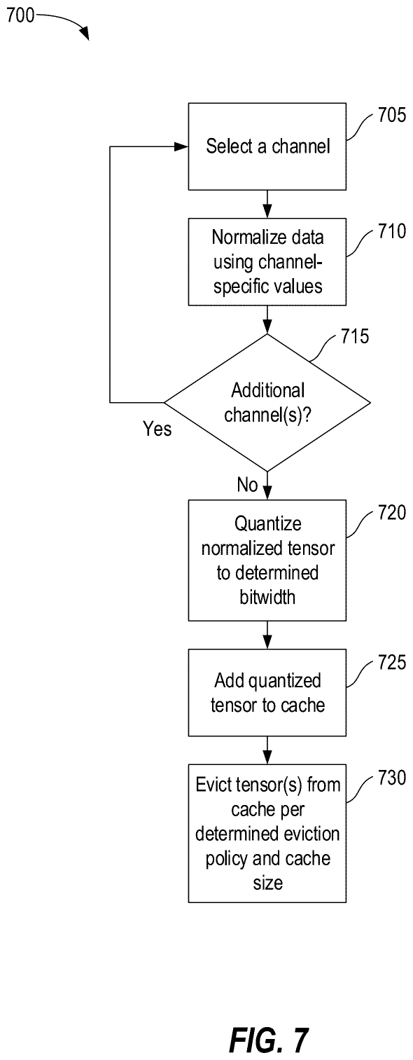

FIG. 7 is a flow diagram depicting an example method 700 for normalizing, quantizing, and caching data using optimized (or at least improved) hyperparameters, according to some aspects of the present disclosure. In some aspects, the method 700 is performed by a computing system, such as an optimization system (e.g., the optimization system 125 of FIG. 1) and/or the computing system discussed above with reference to FIGS. 2-6. In some aspects, the method 700 provides more detail for the block 640 of FIG. 6. In some aspects, the method 700 is performed for each tensor that is cached by the model.

At block 705, the computing system selects a channel from the to-be-cached tensor (e.g., the key tensor and/or value tensor generated based on the next input token). Generally, the computing system may select the channel using a variety of techniques, including randomly or pseudo-randomly, as each channel in the tensor will be processed during the method 700.

At block 710, the computing system normalizes the data in the selected channel. In various aspects, the computing system may normalize the data using the channel-specific normalization data for the channel. For example, as discussed above, the computing system may subtract the channel-specific average value from each element in the selected channel, and then divide the result by the channel-specific maximum value for the channel. As discussed above, this may serve to normalize the channels (e.g., to a range of −1 to 1) which may reduce quantization loss.

At block 715, the computing system determines whether there is at least one additional channel remaining in the current tensor. If so, the method 700 returns to block 705. If all channels in the tensor have been normalized, the method 700 continues to block 720. Although the illustrated example depicts a sequential process (selecting and normalizing each channel iteratively) for conceptual clarity, in some aspects, the computing system may normalize some or all of the channels in parallel.

At block 720, the computing system quantizes the normalized tensor to the determined bitwidth (e.g., the cache or quantization bitwidth that was selected for the layer). At block 725, the computing system then adds the quantized tensor to the cache of the current layer.

At block 730, the computing system can optionally evict one or more tensor(s) from the cache based on the determined eviction policy for the layer and the determined cache size for the layer. For example, as discussed above, if adding the data at block 725 resulted in the cache meeting or exceeding its defined maximum size, the computing system may select one or more tokens (using the cache eviction policy) currently stored in the cache, and may evict these selected token(s) from the cache.

### Example Method for Efficient Machine Learning

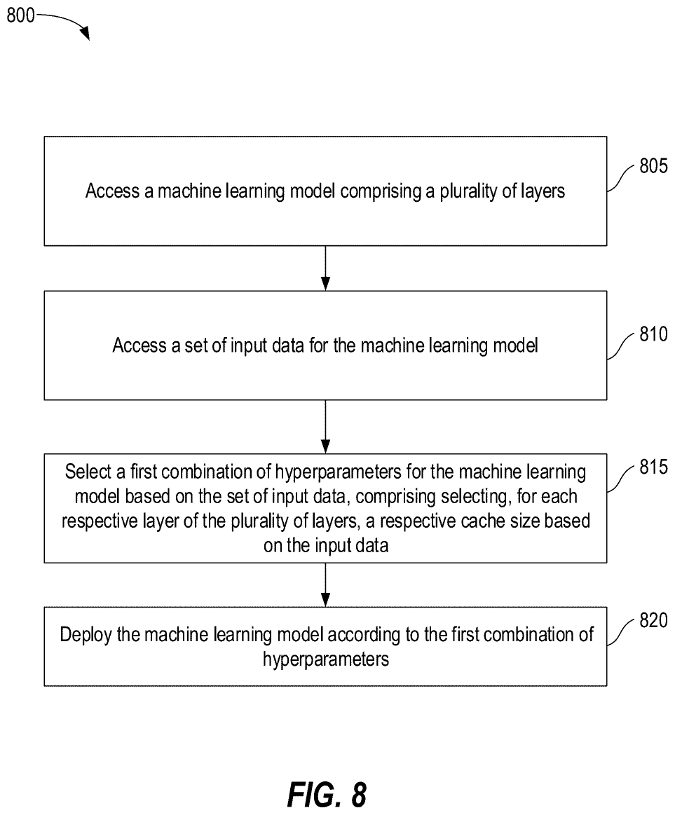

FIG. 8 is a flow diagram depicting an example method 800 for efficient machine learning, according to some aspects of the present disclosure. In some aspects, the method 800 is performed by a computing system, such as an optimization system (e.g., the optimization system 125 of FIG. 1) and/or the computing system discussed above with reference to FIGS. 2-7.

At block 805, a machine learning model comprising a plurality of layers is accessed.

At block 810, a set of input data for the machine learning model is accessed.

At block 815, a first combination of hyperparameters for the machine learning model is selected based on the set of input data, comprising selecting, for each respective layer of the plurality of layers, a respective cache size based on the input data.

At block 820, the machine learning model is deployed according to the first combination of hyperparameters.

In some aspects, selecting the respective cache size for each respective layer of the plurality of layers comprises selecting, for each respective layer, (i) a small cache size, (ii) a medium cache size, or (iii) a large cache size.

In some aspects, selecting the respective cache size for each respective layer of the plurality of layers comprises determining that the respective cache sizes for the plurality of layers sum to no greater than a defined maximum memory footprint.

In some aspects, selecting the first combination of hyperparameters further comprises selecting, for each respective layer of the plurality of layers, a respective quantization bitwidth based on the input data.

In some aspects, the method 800 further includes determining, for each respective channel of a plurality of channels in a tensor generated by a first layer of the plurality of layers, respective channel-specific normalization data, comprising: determining a respective average value of the respective channel based on the set of input data; and determining a respective maximum value of the respective channel based on the set of input data.

In some aspects, deploying the machine learning model according to the first combination of hyperparameters comprises indicating the channel-specific normalization data such that, during inferencing by the machine learning model, the channel-specific normalization data can be used to normalize each channel of the tensor prior to quantizing the tensor and storing the quantized tensor in a cache associated with the first layer.

In some aspects, selecting the first combination of hyperparameters further comprises selecting, for each respective layer of the plurality of layers, a respective token eviction policy for a respective cache based on the input data.

In some aspects, the respective cache sizes for the plurality of layers correspond to a set of key-value (KV) caches for a set of attention mechanisms of the machine learning model.

In some aspects, the method 800 further includes evaluating the first combination of hyperparameters for the machine learning model using the set of input data; and evaluating a second combination of hyperparameters for the machine learning model using the set of input data, wherein selecting the first combination of hyperparameters is performed based on the evaluations.

In some aspects, evaluating the first combination of hyperparameters comprises determining at least one of: (i) a perplexity of the machine learning model when the first combination of hyperparameters is used, (ii) a summarization score of the machine learning model when the first combination of hyperparameters is used, or (iii) an accuracy score of the machine learning model when the first combination of hyperparameters is used.

In some aspects, selecting the first combination of hyperparameters is performed using at least one of: (i) a Bayesian optimization operation, (ii) a genetic algorithm, or (iii) a simulated annealing operation.

### Example Method for Efficient Machine Learning Runtime

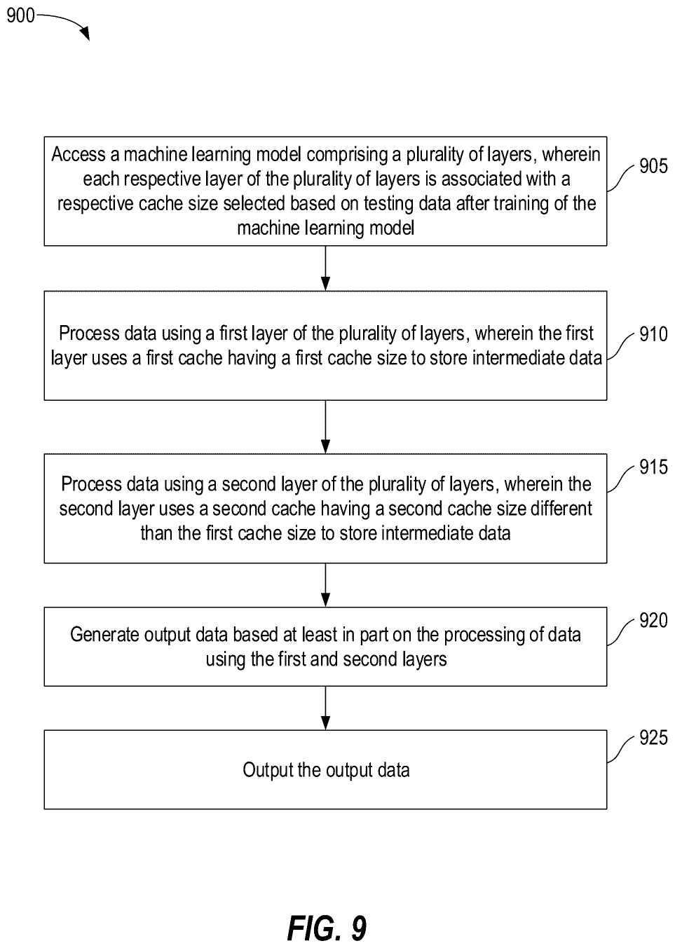

FIG. 9 is a flow diagram depicting an example method 900 for efficient machine learning runtime, according to some aspects of the present disclosure. In some aspects, the method 900 is performed by a computing system, such as an optimization system (e.g., the optimization system 125 of FIG. 1) and/or the computing system discussed above with reference to FIGS. 2-8.

At block 905, a machine learning model comprising a plurality of layers is accessed, wherein each respective layer of the plurality of layers is associated with a respective cache size selected based on testing data after training the machine learning model.

At block 910, data is processed using a first layer of the plurality of layers, wherein the first layer uses a first cache having a first cache size to store intermediate data.

At block 915, data is processed using a second layer of the plurality of layers, wherein the second layer uses a second cache having a second cache size different than the first cache size to store intermediate data.

At block 920, output data is generated based at least in part on the processing of data using the first and second layers.

At block 925, the output data is output.

In some aspects, the first cache size corresponds to one of a set of defined cache sizes for the machine learning model, the set of defined cache sizes including (i) a small cache size, (ii) a medium cache size, or (iii) a large cache size.

In some aspects, a respective cache sizes of each layer of the plurality of layers sums to no more than a defined maximum memory footprint for the machine learning model.

In some aspects, the first cache is associated with a first quantization bitwidth used to store data in the first cache, and the second cache is associated with a second quantization bitwidth, different from the first quantization bitwidth, used to store data in the second cache.

In some aspects, processing the first data using the first layer of the plurality of layers comprises applying channel-specific normalization to intermediate data prior to quantizing the intermediate data and storing the intermediate data in the first cache.

In some aspects, the channel-specific normalization was determined, for each respective channel of the intermediate data, based on a respective average value of the respective channel using testing data and a respective maximum value of the respective channel using testing data.

In some aspects, the first cache is associated with a first token eviction policy for data stored in the first cache, and the second cache is associated with a second token eviction policy, different from the first token eviction policy, used to store data in the second cache.

### Example Processing System for Machine Learning

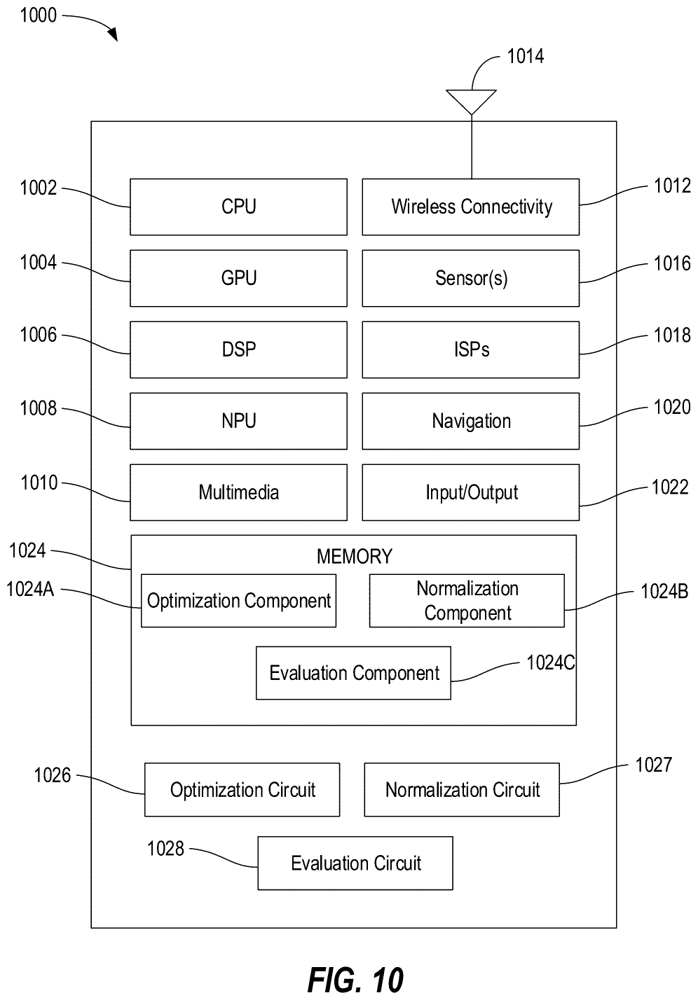

FIG. 10 depicts an example processing system 1000 configured to perform various aspects of the present disclosure, including, for example, the techniques and methods described with respect to FIGS. 1-9. In some aspects, the processing system 1000 may correspond to a computing system. For example, the processing system 1000 may correspond to the optimization system 125 of FIG. 1 and/or the computing system discussed above with reference to FIGS. 2-9. Although depicted as a single system for conceptual clarity, in some aspects, as discussed above, the components described below with respect to the processing system 1000 may be distributed across any number of devices or systems.

The processing system 1000 includes a central processing unit (CPU) 1002, which in some examples may be a multi-core CPU. Instructions executed at the CPU 1002 may be loaded, for example, from a program memory associated with the CPU 1002 or may be loaded from a memory partition (e.g., a partition of a memory 1024).

The processing system 1000 also includes additional processing components tailored to specific functions, such as a graphics processing unit (GPU) 1004, a digital signal processor (DSP) 1006, a neural processing unit (NPU) 1008, a multimedia component 1010 (e.g., a multimedia processing unit), and a wireless connectivity component 1012.

An NPU, such as the NPU 1008, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1008, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference). In some implementations, the NPU 1008 is a part of one or more of the CPU 1002, the GPU 1004, and/or the DSP 1006.

In some examples, the wireless connectivity component 1012 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 1012 is further coupled to one or more antennas 1014.

The processing system 1000 may also include one or more sensor processing units 1016 associated with any manner of sensor, one or more image signal processors (ISPs) 1018 associated with any manner of image sensor, and/or a navigation processor 1020, which may include satellite-based positioning system components (e.g., GPS or GLONASS) as well as inertial positioning system components.

The processing system 1000 may also include one or more input and/or output devices 1022, such as screens, touch-sensitive surfaces (including touch-sensitive displays), physical buttons, speakers, microphones, and the like.

In some examples, one or more of the processors of the processing system 1000 may be based on an ARM or RISC-V instruction set.

The processing system 1000 also includes a memory 1024, which is representative of one or more static and/or dynamic memories, such as a dynamic random access memory, a flash-based static memory, and the like. In this example, the memory 1024 includes computer-executable components, which may be executed by one or more of the aforementioned processors of the processing system 1000.

In particular, in this example, the memory 1024 includes an optimization component 1024A, a normalization component 1024B, and an evaluation component 1024C. Although not depicted in the illustrated example, the memory 1024 may also include other components, such as a training component used to train or update machine learning model(s), an inferencing component used to manage runtime of the model, and the like. Though depicted as discrete components for conceptual clarity in FIG. 10, the illustrated components (and others not depicted) may be collectively or individually implemented in various aspects.

Further, although not depicted in the illustrated example, the memory 1024 may also include other data such as model parameters (e.g., parameters of one or more machine learning models), training and/or testing data for the machine learning model(s), cache hyperparameter data for the model(s), and the like.

The processing system 1000 further comprises an optimization circuit 1026, a normalization circuit 1027, and an evaluation circuit 1028. The depicted circuits, and others not depicted (such as an inferencing circuit), may be configured to perform various aspects of the techniques described herein.

The optimization component 1024A and/or the optimization circuit 1026 (which may correspond to the optimization component 135 of FIG. 1) may be used to select combinations of hyperparameters for evaluation, as discussed above. For example, the optimization component 1024A and/or the optimization circuit 1026 may use various techniques such as Bayesian optimization, genetic algorithms, simulated annealing, and the like.

The normalization component 1024B and/or the normalization circuit 1027 (which may correspond to the normalization component 140 of FIG. 1) may be used to determine normalization statistics (e.g., per-channel statistics for intermediate tensors) and/or to normalize the intermediate tensors prior to quantization during runtime, as discussed above. For example, the normalization component 1024B and/or the normalization circuit 1027 may be used to collect normalization statistics for each channel using testing data.

The evaluation component 1024C and/or the evaluation circuit 1028 (which may correspond to the evaluation component 145 of FIG. 1) may be used to evaluate combinations of hyperparameters and their impact on model performance, as discussed above. For example, the evaluation component 1024C and/or the evaluation circuit 1028 may use various techniques to score or quantify the performance of the model (e.g., based on perplexity, accuracy, summarization, and the like) when a given combination of cache hyperparameters is used.

Though depicted as separate components and circuits for clarity in FIG. 10, the optimization circuit 1026, the normalization circuit 1027, and the evaluation circuit 1028 may collectively or individually be implemented in other processing devices of the processing system 1000, such as within the CPU 1002, the GPU 1004, the DSP 1006, the NPU 1008, and the like.

Generally, the processing system 1000 and/or components thereof may be configured to perform the methods described herein.

Notably, in other aspects, aspects of the processing system 1000 may be omitted, such as where the processing system 1000 is a server computer or the like. For example, the multimedia component 1010, the wireless connectivity component 1012, the sensor processing units 1016, the ISPs 1018, and/or the navigation processor 1020 may be omitted in other aspects. Further, aspects of the processing system 1000 may be distributed between multiple devices.

### Example Clauses

Implementation examples are described in the following numbered clauses:
Clause 1: A method, comprising: accessing a machine learning model comprising a plurality of layers; accessing a set of input data for the machine learning model; selecting a first combination of hyperparameters for the machine learning model based on the set of input data, comprising selecting, for each respective layer of the plurality of layers, a respective cache size based on the input data; and deploying the machine learning model according to the first combination of hyperparameters.
Clause 2: A method according to Clause 1, wherein selecting the respective cache size for each respective layer of the plurality of layers comprises selecting, for each respective layer, (i) a small cache size, (ii) a medium cache size, or (iii) a large cache size.
Clause 3: A method according to any of Clauses 1-2, wherein selecting the respective cache size for each respective layer of the plurality of layers comprises determining that the respective cache sizes for the plurality of layers sum to no greater than a defined maximum memory footprint.
Clause 4: A method according to any of Clauses 1-3, wherein selecting the first combination of hyperparameters further comprises selecting, for each respective layer of the plurality of layers, a respective quantization bitwidth based on the input data.
Clause 5: A method according to Clause 4, further comprising, determining, for each respective channel of a plurality of channels in a tensor generated by a first layer of the plurality of layers, respective channel-specific normalization data, comprising: determining a respective average value of the respective channel based on the set of input data; and determining a respective maximum value of the respective channel based on the set of input data.
Clause 6: A method according to Clause 5, wherein deploying the machine learning model according to the first combination of hyperparameters comprises indicating the channel-specific normalization data such that, during inferencing by the machine learning model, the channel-specific normalization data can be used to normalize each channel of the tensor prior to quantizing the tensor and storing the quantized tensor in a cache associated with the first layer.
Clause 7: A method according to any of Clauses 1-6, wherein selecting the first combination of hyperparameters further comprises selecting, for each respective layer of the plurality of layers, a respective token eviction policy for a respective cache based on the input data.
Clause 8: A method according to any of Clauses 1-7, wherein the respective cache sizes for the plurality of layers correspond to a set of key-value (KV) caches for a set of attention mechanisms of the machine learning model.
Clause 9: A method according to any of Clauses 1-8, further comprising: evaluating the first combination of hyperparameters for the machine learning model using the set of input data; and evaluating a second combination of hyperparameters for the machine learning model using the set of input data, wherein selecting the first combination of hyperparameters is performed based on the evaluations.
Clause 10: A method according to Clause 9, wherein evaluating the first combination of hyperparameters comprises determining at least one of: (i) a perplexity of the machine learning model when the first combination of hyperparameters is used, (ii) a summarization score of the machine learning model when the first combination of hyperparameters is used, or (iii) an accuracy score of the machine learning model when the first combination of hyperparameters is used.
Clause 11: A method according to any of Clauses 1-10, wherein selecting the first combination of hyperparameters is performed using at least one of: (i) a Bayesian optimization operation, (ii) a genetic algorithm, or (iii) a simulated annealing operation.
Clause 12: A method, comprising: accessing a machine learning model comprising a plurality of layers, wherein each respective layer of the plurality of layers is associated with a respective cache size selected based on testing data after training the machine learning model; processing input data to generate output data using the machine learning model, comprising: processing data using a first layer of the plurality of layers, wherein the first layer uses a first cache having a first cache size to store intermediate data; and processing data using a second layer of the plurality of layers, wherein the second layer uses a second cache having a second cache size different than the first cache size to store intermediate data; and outputting the output data.
Clause 13: A method according to Clause 12, wherein the first cache size corresponds to one of a set of defined cache sizes for the machine learning model, the set of defined cache sizes including (i) a small cache size, (ii) a medium cache size, or (iii) a large cache size.
Clause 14: A method according to any of Clauses 12-13, wherein a respective cache sizes of each layer of the plurality of layers sums to no more than a defined maximum memory footprint for the machine learning model.
Clause 15: A method according to any of Clauses 12-14, wherein: the first cache is associated with a first quantization bitwidth used to store data in the first cache, and the second cache is associated with a second quantization bitwidth, different from the first quantization bitwidth, used to store data in the second cache.
Clause 16: A method according to Clause 15, wherein processing the first data using the first layer of the plurality of layers comprises applying channel-specific normalization to intermediate data prior to quantizing the intermediate data and storing the intermediate data in the first cache.
Clause 17: A method according to Clause 16, wherein the channel-specific normalization was determined, for each respective channel of the intermediate data, based on a respective average value of the respective channel using testing data and a respective maximum value of the respective channel using testing data.
Clause 18: A method according to any of Clauses 12-17, wherein: the first cache is associated with a first token eviction policy for data stored in the first cache, and the second cache is associated with a second token eviction policy, different from the first token eviction policy, used to store data in the second cache.
Clause 19: A processing system comprising: a memory comprising processor-executable instructions; and one or more processors coupled to the one or more memories and configured to execute the processor-executable instructions and cause the processing system to perform a method in accordance with any of Clauses 1-17.
Clause 20: A processing system comprising means for performing a method in accordance with any of Clauses 1-17.
Clause 21: A non-transitory computer-readable medium comprising computer-executable instructions that, when executed by one or more processors of a processing system, cause the processing system to perform a method in accordance with any of Clauses 1-17.
Clause 22: A computer program product embodied on a computer-readable storage medium comprising code for performing a method in accordance with any of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors coupled to the one or more memories and configured to execute the processor-executable instructions and cause the processing system to:
access a machine learning model comprising a plurality of layers;
access a set of input data for the machine learning model;
select a first combination of hyperparameters for the machine learning model based on the set of input data, comprising selecting, for each respective layer of the plurality of layers, a respective cache size based on the input data; and
deploy the machine learning model according to the first combination of hyperparameters.

2. The processing system of claim 1, wherein, to select the respective cache size for each respective layer of the plurality of layers, the one or more processors are configured to execute the processor-executable instructions and cause the processing system to select, for each respective layer, (i) a small cache size, (ii) a medium cache size, or (iii) a large cache size.

3. The processing system of claim 1, wherein, to select the respective cache size for each respective layer of the plurality of layers, the one or more processors are configured to execute the processor-executable instructions and cause the processing system to determine that the respective cache sizes for the plurality of layers sum to no greater than a defined maximum memory footprint.

4. The processing system of claim 1, wherein, to select the first combination of hyperparameters, the one or more processors are configured to execute the processor-executable instructions and cause the processing system to select, for each respective layer of the plurality of layers, a respective quantization bitwidth based on the input data.

5. The processing system of claim 4, wherein the one or more processors are configured to execute the processor-executable instructions and further cause the processing system to determine, for each respective channel of a plurality of channels in a tensor generated by a first layer of the plurality of layers, respective channel-specific normalization data, wherein, to determine the respective channel-specific normalization data, the one or more processors are configured to execute the processor-executable instructions and cause the processing system to:
determine a respective average value of the respective channel based on the set of input data; and
determine a respective maximum value of the respective channel based on the set of input data.

6. The processing system of claim 5, wherein, to deploy the machine learning model according to the first combination of hyperparameters, the one or more processors are configured to execute the processor-executable instructions and cause the processing system to indicate the channel-specific normalization data such that, during inferencing by the machine learning model, the channel-specific normalization data can be used to normalize each channel of the tensor prior to quantizing the tensor and storing the quantized tensor in a cache associated with the first layer.

7. The processing system of claim 1, wherein, to select the first combination of hyperparameters, the one or more processors are configured to execute the processor-executable instructions and cause the processing system to select, for each respective layer of the plurality of layers, a respective token eviction policy for a respective cache based on the input data.

8. The processing system of claim 1, wherein the respective cache sizes for the plurality of layers correspond to a set of key-value (KV) caches for a set of attention mechanisms of the machine learning model.

9. The processing system of claim 1, wherein the one or more processors are configured to execute the processor-executable instructions and further cause the processing system to:
evaluate the first combination of hyperparameters for the machine learning model using the set of input data; and
evaluate a second combination of hyperparameters for the machine learning model using the set of input data, wherein the first combination of hyperparameters is selected based on the evaluations.

10. The processing system of claim 9, wherein, to evaluate the first combination of hyperparameters, the one or more processors are configured to execute the processor-executable instructions and cause the processing system to determine at least one of:
(i) a perplexity of the machine learning model when the first combination of hyperparameters is used,
(ii) a summarization score of the machine learning model when the first combination of hyperparameters is used, or
(iii) an accuracy score of the machine learning model when the first combination of hyperparameters is used.

11. The processing system of claim 1, wherein, to select the first combination of hyperparameters, the one or more processors are configured to execute the processor-executable instructions and cause the processing system to use at least one of:
(i) a Bayesian optimization operation,
(ii) a genetic algorithm, or
(iii) a simulated annealing operation.

12. A processor-implemented method for machine learning, comprising:
accessing a machine learning model comprising a plurality of layers;
accessing a set of input data for the machine learning model;
selecting a first combination of hyperparameters for the machine learning model based on the set of input data, comprising selecting, for each respective layer of the plurality of layers, a respective cache size based on the input data; and
deploying the machine learning model according to the first combination of hyperparameters.

13. The processor-implemented method of claim 12, wherein selecting the respective cache size for each respective layer of the plurality of layers comprises selecting, for each respective layer, (i) a small cache size, (ii) a medium cache size, or (iii) a large cache size.

14. The processor-implemented method of claim 12, wherein selecting the respective cache size for each respective layer of the plurality of layers comprises determining that the respective cache sizes for the plurality of layers sum to no greater than a defined maximum memory footprint.

15. The processor-implemented method of claim 12, wherein selecting the first combination of hyperparameters further comprises selecting, for each respective layer of the plurality of layers, a respective quantization bitwidth based on the input data.

16. The processor-implemented method of claim 15, further comprising, determining, for each respective channel of a plurality of channels in a tensor generated by a first layer of the plurality of layers, respective channel-specific normalization data, comprising:
determining a respective average value of the respective channel based on the set of input data; and
determining a respective maximum value of the respective channel based on the set of input data.

17. The processor-implemented method of claim 16, wherein deploying the machine learning model according to the first combination of hyperparameters comprises indicating the channel-specific normalization data such that, during inferencing by the machine learning model, the channel-specific normalization data can be used to normalize each channel of the tensor prior to quantizing the tensor and storing the quantized tensor in a cache associated with the first layer.

18. The processor-implemented method of claim 12, wherein selecting the first combination of hyperparameters further comprises selecting, for each respective layer of the plurality of layers, a respective token eviction policy for a respective cache based on the input data.

19. The processor-implemented method of claim 12, further comprising:
evaluating the first combination of hyperparameters for the machine learning model using the set of input data; and
evaluating a second combination of hyperparameters for the machine learning model using the set of input data, wherein selecting the first combination of hyperparameters is performed based on the evaluations.

20. A processing system for machine learning comprising:
one or more memories comprising processor-executable instructions; and
one or more processors coupled to the one or more memories and configured to execute the processor-executable instructions and cause the processing system to:
access a machine learning model comprising a plurality of layers, wherein each respective layer of the plurality of layers is associated with a respective cache size selected based on testing data after training the machine learning model;
process input data to generate output data using the machine learning model, wherein, to process the input data to generate the output data, the one or more processor are configured to execute the processor-executable instructions and cause the processing system to:
process first data using a first layer of the plurality of layers, wherein the first layer uses a first cache having a first cache size to store first intermediate data; and
process second data using a second layer of the plurality of layers, wherein the second layer uses a second cache having a second cache size different than the first cache size to store second intermediate data; and
output the output data.

21. The processing system of claim 20, wherein the first cache size corresponds to one of a set of defined cache sizes for the machine learning model, the set of defined cache sizes including (i) a small cache size, (ii) a medium cache size, or (iii) a large cache size.

22. The processing system of claim 20, wherein a respective cache sizes of each layer of the plurality of layers sums to no more than a defined maximum memory footprint for the machine learning model.

23. The processing system of claim 20, wherein:
the first cache is associated with a first quantization bitwidth used to store data in the first cache, and
the second cache is associated with a second quantization bitwidth, different from the first quantization bitwidth, used to store data in the second cache.

24. The processing system of claim 23, wherein, to process the first data using the first layer of the plurality of layers, the one or more processor are configured to execute the processor-executable instructions and cause the processing system to apply channel-specific normalization to intermediate data prior to quantizing the intermediate data and storing the intermediate data in the first cache.

25. The processing system of claim 24, wherein the channel-specific normalization was determined, for each respective channel of the intermediate data, based on a respective average value of the respective channel using testing data and a respective maximum value of the respective channel using testing data.

26. The processing system of claim 20, wherein:
the first cache is associated with a first token eviction policy for data stored in the first cache, and
the second cache is associated with a second token eviction policy, different from the first token eviction policy, used to store data in the second cache.
